(19) United States
(12) Patent Application Publication
(10) Pub. No.: US 2008/0130676 A1
(43) Pub. Date: Jun. 5, 2008

(54) METHOD AND SYSTEM FOR COLLISION AVOIDANCE USING SLEEP FRAMES

(75) Inventors: Peijuan Liu, Palatine, IL (US); Xiang Chen, Rolling Meadows, IL (US); Ravindra P. Moorut, Barrington, IL (US); Floyd D. Simpson, Lake Worth, FL (US); Dominic M. Tolli, Libertyville, IL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/674,433

(22) Filed: Feb. 13, 2007

Related U.S. Application Data
(60) Provisional application No. 60/868,017, filed on Nov. 30, 2006.

(51) Int. Cl. H04L 12/413

(52) U.S. Cl. 370/445

(57) ABSTRACT

The invention concerns a method (600) and device (100) for collision avoidance using sleep frames (720). The method can include the step of—in a multi-mode device (100)—conducting (630) a communication in accordance with an 802.16 communications protocol in which the 802.16 communication protocol communication includes both listening frames (710) and sleep frames. The method can also include the step of conducting (640) in the multi-mode device another communication in accordance with a Bluetooth communications protocol that supports extended synchronous connection-oriented mode. The method can also include the step of arranging (640) transmissions of the Bluetooth communication to avoid collisions with transmissions of the 802.16 communication.

### CROSS-REFERENCE TO RELATED APPLICATIONS

The present application claims the benefit of U.S. Provisional Application Ser. No. 60/868,017, filed Nov. 30, 2006, which is hereby incorporated by reference herein.

### BACKGROUND OF THE INVENTION

1. Field of the Invention

The present invention concerns limiting collisions and more particularly, limiting collisions between a short range wireless system and a wide area wireless system.

2. Description of the Related Art

In recent years, mobile communications devices have been developed in which such devices operate in accordance with various wireless protocols. For example, many handsets are configured to operate in a code division multiple access (CDMA) network and include an accompanying Bluetooth transceiver to permit a user to engage in a hands-free conversation. These handsets may be referred to as multi-mode communication devices, or simply multi-mode devices.

Multi-mode devices that support operations in accordance with the Institute for Electrical and Electronics Engineers (IEEE) standard 802.16 and that include Bluetooth transceivers are currently being developed. One possible frequency band for the 802.16 standard runs from 2.496 GHz to 2.69 GHz, while one possible frequency allocation for Bluetooth is from 2.4 GHz to 2.4835 GHz. In a typical scenario for this type of a device, the user of the multi-mode device may use a Bluetooth headset while engaged in a Voice over Internet Protocol (VoIP) call. Harmonious coexistence of these two transmissions, however, cannot be achieved in the radio frequency (RF) layer in view of the compact size of the multi-mode device and the close proximity of the operating spectrum. In particular, harmful interference will arise in the multi-mode device when one technology transmits while the other attempts to receive.

### SUMMARY OF THE INVENTION

The present invention concerns a method and system for collision avoidance using sleep frames. The method can include the step of—in a multi-mode device—conducting a communication in accordance with an 802.16 communications protocol in which the 802.16 communication protocol communication includes both listening frames and sleep frames. The method can also include the steps of conducting in the multi-mode device another communication in accordance with a Bluetooth communications protocol that supports extended synchronous connection-oriented mode and arranging transmissions of the Bluetooth communication to avoid collisions with transmissions of the 802.16 communication.

The method can further include the steps of requesting from a base station that supports the 802.16 communication a cluster of frames having a designated number of listening frames and sleep frames and receiving from the base station a grant of the cluster of frames. As an example, the cluster of frames can have two listening frames and one sleep frame, each of which can be approximately five milli-seconds in duration.

In one arrangement, the listening frames can include a downlink subframe and an uplink subframe, and the method can further include the step of receiving downlink burst and uplink burst allocations respectively in the downlink subframe and the uplink subframe of the listening frames. In addition, the Bluetooth communication can include a cycle time of approximately 7.5 milli-seconds, of which approximately 1.25 milli-seconds can be occupied by a transmission slot and a receive slot. Moreover, arranging transmissions of the Bluetooth communication to avoid collisions with transmissions of the 802.16 communication can include offsetting the boundaries of the transmission and receive slots of the Bluetooth communication with respect to the boundaries of the listening and sleep frames of the 802.16 communication such that the Bluetooth transmission and receive slots are transmitted at a time when no downlink or uplink bursts are scheduled to occur in the listening frames.

As an example, offsetting the boundaries of the transmission and receive slots of the Bluetooth communication can include reading the sleep frame of the 802.16 communication and setting an ending boundary of the Bluetooth transmission and receive slots prior to the start of the next consecutive listening frame. As another example, a starting boundary of the Bluetooth transmission and receive slots can be set to be the later of approximately 2.5 milli-seconds from the end of the sleep frame or the end of the downlink subframe of the next consecutive listening frame.

In another arrangement, the multi-mode device can communicate with an accessory over the Bluetooth communications protocol, and the multi-mode device can be designated as a master. The method can also include the step of determining whether the multi-mode device is the master of the relationship between the multi-mode device and the accessory. The method can further include the step of switching the multi-mode device to the master if the multi-mode device is not designated as such to ensure that the multi-mode device is the master when the multi-mode device communicates with the accessory.

The present invention also concerns another method for collision avoidance using sleep frames. The method can include the step of—at a base station that supports 802.16 communications—receiving from a multi-mode device through an 802.16 communication a request for a cluster of frames having a designated number of listening frames and sleep frames. The method can also include the steps of granting the request for the cluster of frames in which the cluster of frames can include two listening frames and one sleep frame and allocating uplink bursts and downlink bursts in the listening frames of the cluster of frames to permit the multi-mode device to arrange the transmissions of an extended synchronous connection-oriented Bluetooth communication to avoid collisions with the 802.16 communication.

The present invention is also directed to a multi-mode device. The multi-mode device can include a transceiver capable of conducting an 802.16 communication having both listening and sleep frames, a transceiver capable of conducting an extended synchronous connection-oriented Bluetooth communication and a collision avoidance module coupled to the first and second transceivers. The collision avoidance module can arrange transmissions of the Bluetooth transceiver to avoid collisions with transmissions of the 802.16 transceiver. The multi-mode device can include suitable software and circuitry for carrying out any of the processes described herein.

The present invention also concerns a base station that supports 802.16 communications. The base station can include a transceiver that receives from a multi-mode device through an 802.16 communication a request for a cluster of frames having a designated number of listening frames and sleep frames and can include a generating module. The generating module can grant the request for the cluster of frames in which the cluster of frames can include two listening frames and one sleep frame and can allocate uplink bursts and downlink bursts in the listening frames of the cluster of frames to permit the multi-mode device to arrange the transmissions of an extended synchronous connection-oriented Bluetooth communication to avoid collisions with the 802.16 communication. The base station can also include suitable software and circuitry for executing any suitable process described herein.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a usage scenario in accordance with an embodiment of the inventive arrangements;

FIG. 2 illustrates block diagrams of certain components in accordance with an embodiment of the inventive arrangements;

FIG. 3 illustrates a portion of an 802.16 communication frame in accordance with an embodiment of the inventive arrangements;

FIG. 4 illustrates a cycle of listening and sleep frames in accordance with an embodiment of the inventive arrangements;

FIG. 5 illustrates a Bluetooth communication cycle in accordance with an embodiment of the inventive arrangements;

FIG. 6 illustrates a method for collision avoidance in accordance with an embodiment of the inventive arrangements; and

FIG. 7 illustrates an 802.16 communication cycle and a Bluetooth communication cycle in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein.

The term “multi-mode device” can be defined as any electronic device capable of receiving and/or transmitting two or more different communication signals, some of which may be in accordance with different communications protocols. The term “transceiver” can be any component or group of components that are capable of receiving and transmitting communications signals. A “collision” can mean any interference between at least two different communication signals due to simultaneous transmission or reception of the communication signals at a multi-mode device. The term “approximate” or “approximately” can refer to the actual value modified by such term and any variations from that actual value so long as such variations do not interfere with minimizing collisions between two or more different communications.

The term “transmission” can mean the actual transmission of a signal and/or the receipt of a signal. The term “listening frame” can refer to a frame in which the receiver or transceiver of the device receiving such a frame is active for at least a portion of that frame. Conversely, the term “sleep frame” can refer to a frame in which the receiver or transceiver of the device receiving such a frame is deactivated for the entirety of that frame.

The invention concerns a method and system for collision avoidance using sleep frames. The method can include the step of—in a multi-mode device—conducting a communication in accordance with an 802.16 communications protocol in which the 802.16 communication protocol communication includes both listening frames and sleep frames. The method can also include the step of conducting in the multi-mode device another communication in accordance with a Bluetooth communications protocol that supports extended synchronous connection-oriented (eSCO) mode. The method can also include the step of arranging transmissions of the Bluetooth communication to avoid collisions with transmissions of the 802.16 communication. This process can improve a user's experience when the user is on, for example, a VoIP call on a wireless handset while using a Bluetooth headset that is wirelessly coupled to the handset.

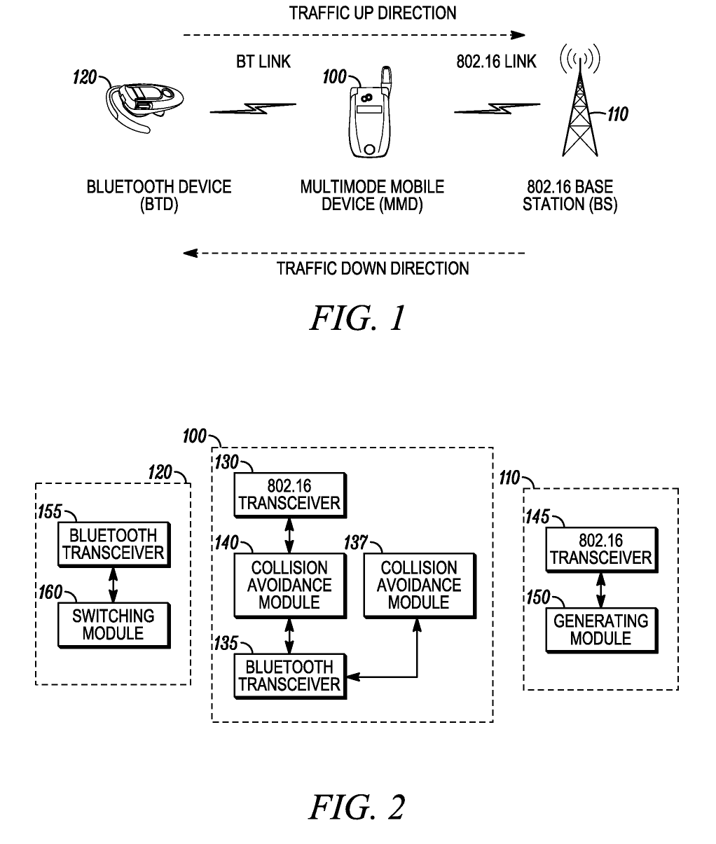

Referring to FIG. 1, an example of a usage scenario is presented. In this example, a multi-mode device 100 is communicating with a base station 110. In one arrangement, this communication can be an 802.16 communication, and the base station 110 can be referred to as an 802.16 base station. For purposes of the invention, the term “802.16 communication” or a “communication in accordance with an 802.16 communications protocol” can refer to wireless communications that comply with IEEE standard 802.16. As an example, an 802.16 communication can include wireless signals that operate in the frequency band from approximately 2.496 GHz to approximately 2.69 GHz.

The multi-mode device 100 may also be communicating with an accessory 120 over, for example, a Bluetooth communication link. A Bluetooth communication or a communication in accordance with a Bluetooth communications protocol can mean a wireless communication that is intended to have a short range, such as one measured in meters or feet, and that operates in accordance with specifications set forth by the Bluetooth Special Interest Group. As an example, the Bluetooth communication can operate in the frequency band of approximately 2.4 GHz to approximately 2.4835 GHz. The accessory 120 may be referred to as a Bluetooth accessory or device. In one particular example, the multi-mode device 100 may be conducting a VoIP call with the base station 110, while at the same time, the multi-mode device 100 may have an active communication link with the accessory 120.

Referring to FIG. 2, block diagrams of the multi-mode device 100, the base station 110 and the accessory 120 are shown. In one arrangement, the multi-mode device 100 can include an 802.16 transceiver 130, a Bluetooth transceiver 135, a device switching module 137 and a collision avoidance module 140. The 802.16 transceiver is capable of conducting an 802.16 communication that includes both sleep frames and listening frames, while the Bluetooth transceiver 135 is capable of conducting an eSCO Bluetooth communication. As will be described below, the collision avoidance module 140, which can be coupled to both the 802.16 transceiver 130 and the Bluetooth transceiver 135, can arrange transmissions of the Bluetooth transceiver 135 to avoid collisions with the 802.16 transceiver 130. In addition, the device switching module 137 can ensure that the multi-mode device 100 is the master in its relationship with the accessory 120. The collision avoidance module 140 and the device switching module 137 can contain any suitable number of hardware and/or software components for carrying out any relevant processes.

In another arrangement, the base station 110 can include a transceiver 145 that can receive from the multi-mode device 100 through an 802.16 communication a request for a cluster of frames having a designated number of listening frames and sleep frames. The base station 110 can also include a generating module 150 that can grant the requested cluster of frames and can allocate uplink (UL) bursts and downlink (DL) bursts in the listening frames of the cluster of frames to permit the multi-mode device 100 to arrange the transmissions of the eSCO Bluetooth communication to avoid collisions with the 802.16 communication. Similar to the collision avoidance module 140, the generating module 150 can include any suitable number of hardware and/or software components for performing the functions described herein.

The accessory 120 can include a Bluetooth transceiver 155 for communicating with the multi-mode device 100. In addition, the accessory 120 can include a switching module 160. The switching module 160 can assist in ensuring that the multi-mode device 100 is designated as the master unit in the relationship between the multi-mode device 100 and the accessory 120. For example, when a communication between the accessory 120 and the multi-mode device 100 is initiated, the device switching module 137 can determine whether the device 100 is designated as the master of this relationship. If the device 100 is not the master, then the device switching module 137 can switch the role of the device 100 from the slave to the master, and this switch request can be accepted and processed by the switching module 160 of the accessory 120. Where appropriate, the switching module 160 can respond with slot offset. It is beneficial to have the multi-mode device 100 act as the master in this relationship, as the multi-mode device 100 is aware of the timing of the 802.16 communication.

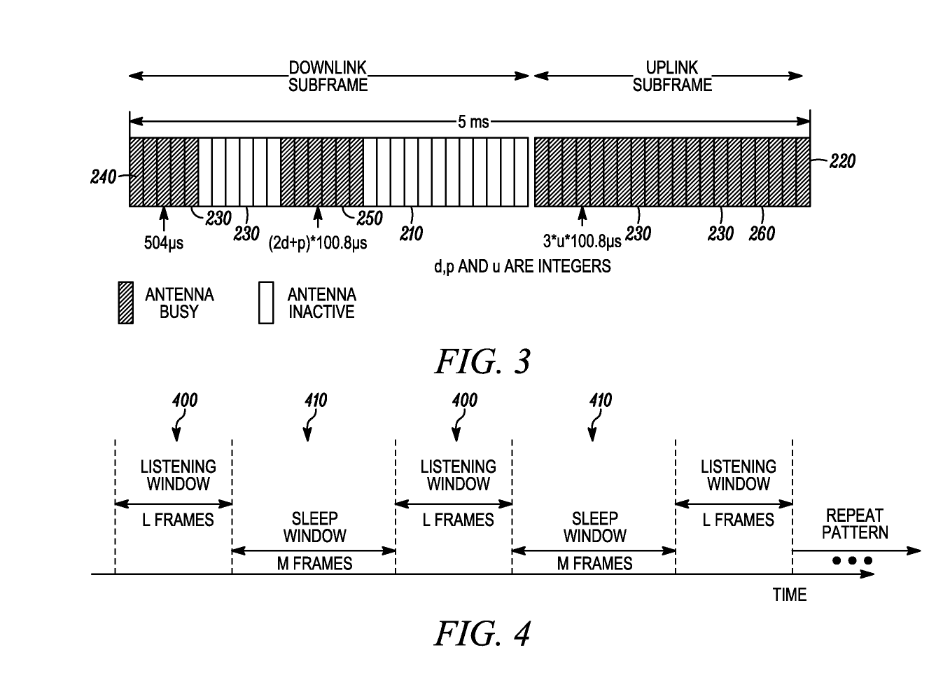

As is known in the art, an 802.16 communication includes a plurality of time division duplex (TDD) frames that are about 5 milli-seconds (ms) in duration. Referring to FIG. 3, an example of a portion of a frame 200 that is present in an 802.16 communication is shown (for brevity, transition times are not shown here). The frame 200 includes a DL subframe 210 and an UL subframe 220, and both the DL subframe 210 and the UL subframe 220 are made up of an integer number of orthogonal frequency division multiplexing (OFDM) or orthogonal frequency division multiple access (OFDMA) symbols 230, or simply, symbols 230. These symbols 230 are approximately 100.8 micro-seconds (μs) in length.

Part of the DL subframe 210 can include a set-up portion 240, which may include such things as a preamble, a frame control header (FCH), a DL-MAP and an UL-MAP. The multi-mode device 100 (see FIG. 1) can use this information to determine when and how to transmit and/or receive relevant packets in the frame 200 and possibly the next consecutive frame 200. In particular, the DL-MAP specifies the burst information for the current DL subframe 210, and the UL map provides burst information for the UL subframe 220 in the next consecutive frame 200. As such, the multi-mode device 100 is required to decode the set-up portion 240, and the set-up portion 240 may occupy about five to eight or more symbols 230. In this example, the set-up portion 240 is shown as occupying five symbols 230, which have been shaded and is equivalent to roughly 540 μs in time.

As alluded to earlier, the DL subframe 210 may include a DL burst 250, which is shown as being shaded in FIG. 3. As is known in the art, the minimum allocation unit is two symbols 230 by a subchannel, i.e., the minimum burst width is two symbols 230. A scheduler in the base station 110 (see FIG. 1) actually decides this allocation, and accordingly, from the time domain, the DL burst 250 may occupy 2*d (where d is an integer) symbols 230 anywhere within the available DL subframe 210, except for the symbols 230 taken up by the set-up portion 240. Furthermore, it is customary for the multi-mode device 100 to measure the pilot carriers in neighboring symbols 230 around the actual burst to carry out channel estimation, which will improve the decoding success rate of the desired burst.

In this example, this process causes two symbols 230 on either side of the actual burst to be occupied, which means that the DL burst 250 includes six symbols 230. To account for the total number of symbols 230 occupied by the DL burst 250, the value p, which reflects the number of symbols 230 used for the measurement of pilot carriers, is added to 2*d, which is shown in FIG. 3. The number of symbols 230 is then multiplied by 100.8 μs to show the total duration of the DL burst 250.

Similar to the DL subframe 210, the UL subframe 220 includes an UL burst 260, which is also shown in FIG. 3 as being shaded. Those of skill in the art will appreciate that the 802.16 standard specifies that the allocation of the UL burst 260 must span contiguous slots, where each slot is defined as three symbols 230 by a subchannel. Thus, the allocation is first done horizontally (over symbols 230) until reaching the edge of the UL subframe 220, which then continues from the first symbol 230 of the next subchannel. From the time domain perspective, the UL burst 260 may occupy 3*u symbols, where u is an integer dependent on the payload size and modulation and coding scheme associated with the UL burst 260. Accordingly, in the time domain, it is possible that the UL burst 260 may take up the entire UL subframe 220, if a VoIP packet is scheduled for this particular frame 200.

Overall, when both DL and UL transmissions are scheduled in the frame 200, one can see from the shaded portions that only a small gap is available for a competing transmission, such as Bluetooth, to take place. Moreover, the base station 110 randomly schedules the DL burst 250, which makes it even more difficult to avoid collisions between the 802.16 and Bluetooth communications.

One way to minimize collisions is to reduce the amount of time that the 802.16 transceiver 130 is active, which can be done by skipping the set-up portion 240 of certain frames 200. For example, with VoIP traffic in which a voice packet is scheduled in each direction roughly every 20 ms, it is unlikely that there is a scheduled transmission and reception in every frame 200. As such, it would be beneficial to ignore to the set-up portion 240 of some frames, while listening to the set-up portion 240 of the frames 200 that are relevant to the multi-mode device 100.

As those of skill in the art will appreciate, the Worldwide Interoperability for Microwave Access (WiMAX) Mobility Profile allows for a power saving scheme, referred to as Power Saving Class, Type 2 (PSC-2), that facilitates this process. In particular, when PSC-2 is activated, sleep intervals of a fixed duration are interleaved with listening intervals in a periodic fashion. An example of this process is shown in FIG. 4 in which a listening window 400 is defined by a number L of frames 200 (see FIG. 3), while a sleep window 410 is defined by a number M of frames 200. The values for L and M are fairly flexible and can be chosen depending on the type of data transmission involved.

As is known in the art, in Bluetooth, synchronous connection-oriented (SCO) mode and eSCO mode are two types of logic links for forming synchronous connections for supporting full duplex audio connections. For SCO mode, a high-quality voice (HV3) packet type has the longest duty cycle. This type of SCO packet carries 240 bits of payload in each direction every six time slots with forward error correction (FEC) encoding, which is equivalent to 3.75 ms worth of speech at a 64 kilobits per second (kbps) encoding rate. The transmissions are strictly periodic with a cycle time equal to six time slots, each one about 625 μs in duration. In addition, the slave (e.g., the accessory 120) responds in the slot immediately after the master (e.g., the multi-mode device 100) addresses to it. Therefore, two consecutive slots are always occupied out of every six slots. Following the Bluetooth transmission activity, about 2.5 ms of idle time remains in the cycle time for the SCO mode.

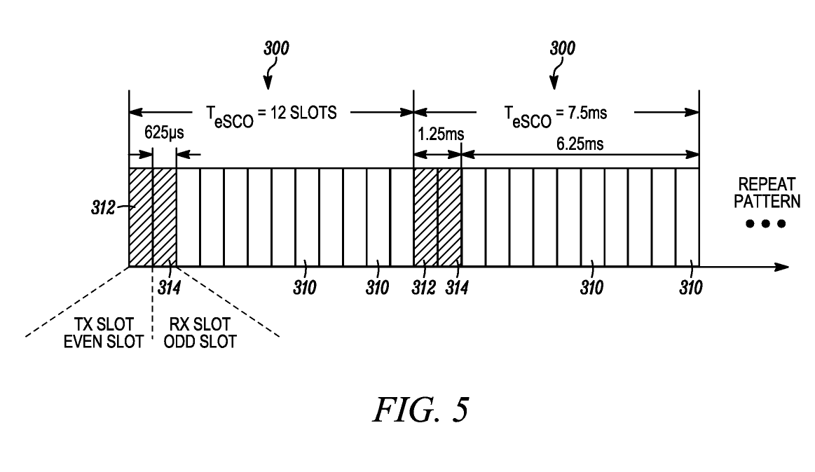

More recent Bluetooth profiles include the optional use of eSCO packet type 2-EV3. In view of a more efficient modulation scheme, a higher duty cycle can be used to carry the same 64 kbps speech of the SCO mode. Referring to FIG. 5, an example of a transmit/receive cycle 300 of 2-EV3 packets of a Bluetooth master device is shown. Here the cycle time (T_{eSCO}) of the cycle 300 is approximately 7.5 ms in duration and includes twelve slots 310, each being about 625 μs. One of the slots 310 is a transmission slot 312 and another is a receive slot 314. As can be seen, the total amount of idle time in the cycle time T_{eSCO} becomes 6.25 ms, which, as will be explained later, can help reduce the chances of collision with an 802.16 communication.

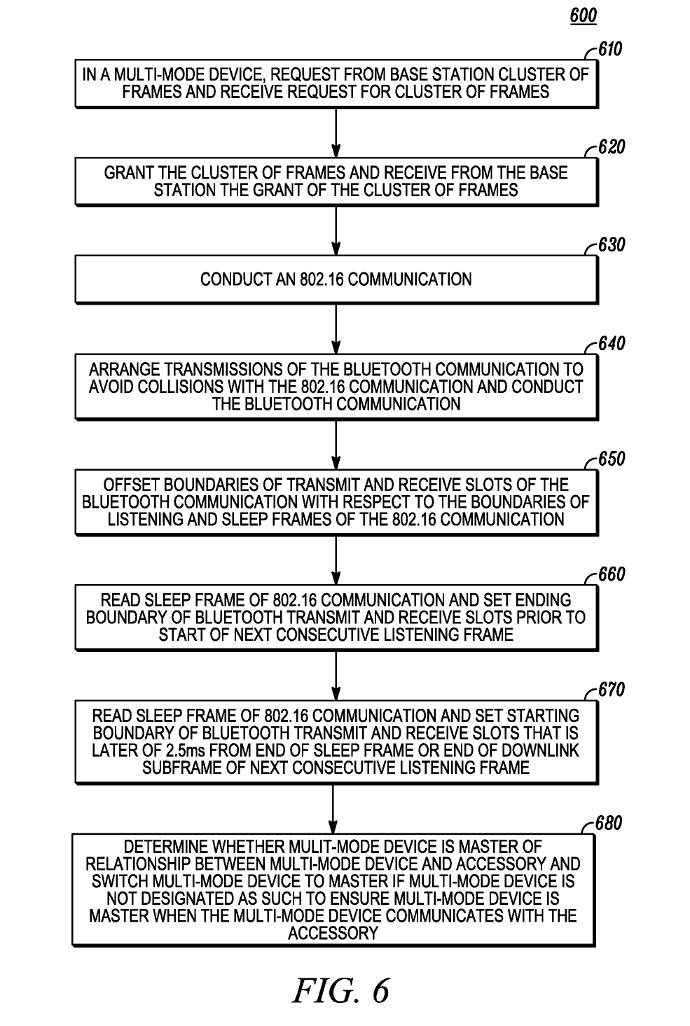

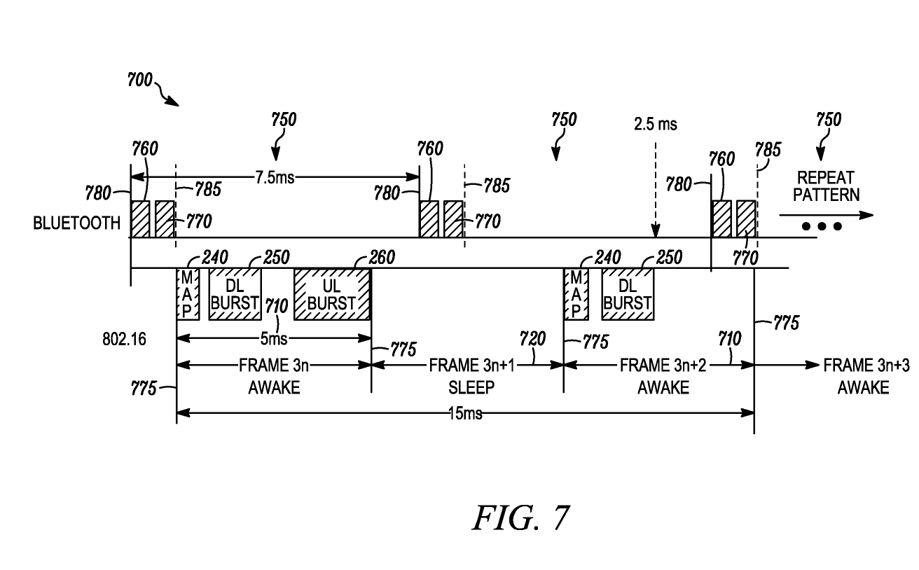

Referring to FIG. 6, a method 600 for collision avoidance is shown. When describing the method 600, reference will be made to FIGS. 1-4, although it is understood that the method 600 may be practiced in any other suitable system or device and in accordance with other transmission schemes. Reference will also be made to FIG. 7, which shows an example of a collision avoidance technique in accordance with the inventive arrangements. The steps of the method 600 are not limited to the particular order in which they are presented in FIG. 6. The inventive method can also have a greater number of steps or a fewer number of steps than those shown in FIG. 6.

At step 610, the multi-mode device 100 can request from the base station 110 a cluster of frames, and the base station 110 can receive this request. As an example, the cluster of frames can have a designated number of listening frames and sleep frames. At step 620, the base station 110 can grant the request for the cluster of frames, and the multi-mode device 100 can receive this grant. An 802.16 communication can then be conducted, as shown at step 630.

As an example, a user of the multi-mode device 100 may wish to initiate a VoIP call on the multi-mode device 100. In response, referring to FIG. 7, the multi-mode device 100 may request and be granted a cluster of frames 700 that includes two listening frames 710 and one sleeping frame 720. The total duration of the cluster of frames 700 can be fifteen ms, with each frame 710, 720 being approximately five ms in length. Such a periodicity is compatible with the standard transmission of packets in a VoIP call.

In the arrangement pictured in FIG. 7, the first listening frame 710 can be referred to as 3n, the sleep frame 720 can be referred to as 3n+1, and the next listening frame 710 can be referred to as 3n+2 in which the value n refers to the number for the current cluster of frames 700. At this point, an 802.16 communication can occur. The listening frames 710 presented here are similar in structure to that presented in FIG. 3. As an example, the listening frame 710 designated as 3n may include a set-up portion 240, a DL burst 250 and an UL burst 260. As another example, the listening frame 710 designated as 3n+2 may include a DL burst 250. The sleep frame 720, designated as 3n+1, contains no such information.

Referring back to the method 600 of FIG. 6, at step 640, transmissions of a Bluetooth communication can be arranged to avoid collisions with the transmission of the 802.16 communication. The Bluetooth communication may be necessary where a user initiates a Bluetooth accessory, such as accessory 120 of FIG. 1. In one arrangement, at step 650, boundaries of transmission and receive slots of the Bluetooth communication can be offset with respect to the boundaries of the listening and sleep frames of the 802.16 communication such that the Bluetooth transmission and receive slots are transmitted at a time when no DL or UL bursts are scheduled to occur in the listening frames.

In particular, at step 660, a sleep frame of the 802.16 communication can be read, and an ending boundary of the Bluetooth transmission and receive slots can be set prior to the start of the next consecutive listening frame. Moreover, in addition to or in lieu of step 660, the sleep frame can be read, and a starting boundary of the Bluetooth transmission and receive slots can be set to the later of approximately 2.5 ms from the end of the sleep frame or the end of the DL subframe of the next consecutive listening frame. Reference will be made once again to FIG. 7 to explain these steps.

As shown in FIG. 7, several Bluetooth transmit/receive cycles 750 are shown, which are structurally similar to those presented in FIG. 5. Here, the transmission slot 760 and the receive slot 770 occupy approximately 1.25 ms of the total duration of approximately 7.5 ms for a transmit/receive cycle 750. The boundaries of these transmission and receive slots 760, 770 can be offset with respect to the listening and sleep frames 710, 720 of the 802.16 communication. For example, the listening frames 710 and the sleep frames 720 can have boundaries 775 that designate (in time, moving from the left) the beginning and ending of these frame 710, 720. As another example, the transmission slots 760 and the receive slots 770 can have starting boundaries 780 and ending boundaries 785 that respectively designate the beginning of the transmission and receive slots 760, 770 and the ending of these slots 760, 770.

Once the multi-mode device 100 is aware of the timing of the 802.16 communication, the device 100 can set the starting boundaries 780 and/or the ending boundaries 785 of the Bluetooth communication to avoid collisions between the two. In one particular example, the collision avoidance module 140 (see FIG. 2) of the multi-mode device 100 can search for and read the sleep frame 720 of the 802.16 communication. Once read, the collision avoidance module 140 can set the ending boundary 785 of the transmission and receive slots 760, 770 prior to the start of the next consecutive listening frame 710, which is designated as frame 3n+3.

Referring to FIG. 7, the module 140 can read the sleep frame 720 designated as 3n+1 and can set the ending boundary 785 prior to the start of (the boundary 775) the next consecutive listening frame 710, which is designated as 3n+3. The collision avoidance module 140, because it is aware of the sleep frame 720, can determine that no UL burst 260 will be present in the listening frame 710 designated as 3n+2 (there is no set-up portion 240 in the sleep frame 720), which allows for the transmission activity of the Bluetooth communication to occur.

As the cycles continue, the timing of the Bluetooth and 802.16 communications ensure that collisions can be avoided between the two. In particular, the next Bluetooth transmission can occur during the next sleep frame 720, which would be designated as 3n+4. This configuration is represented in FIG. 7 with the transmission and receive slots 760, 770 being positioned in the sleep frame 720 designated as 3n+1. Continuing with the example, the next Bluetooth transmission can be scheduled during the next listening frame 710, or one that would be referred to as frame 3n+5, where no UL burst 260 will be present. This scenario is equivalent to the configuration of frame 3n+2.

As can be seen here, the Bluetooth transmission and receive slots 760, 770 can be transmitted at a time when no UL or DL bursts 250, 260 are scheduled to occur in the listening frames 710. Moreover, as an example, in the listening frame 710 designated as 3n+2, there is an opportunity for the allocation of an additional DL burst 250. In fact, in view of this configuration, a DL burst 250 can be allocated in virtually any listening frame 710, which makes it possible to support additional WiMAX traffic streams.

It must be understood that the invention is not limited to this particular arrangement, as there are other possibilities for arranging the Bluetooth transmissions around the 802.16 communication. For example, the transmission and receive slots 760, 770 can be adjusted to occur to the left of that pictured in FIG. 7, if so desired. Specifically, the starting boundary 780 of these slots 760, 770 can be set to at least 2.5 ms after the end of a sleep frame 720, such as the one designated as 3n+1. This time is represented by the dashed arrow positioned above frame 3n+2. Arranging the Bluetooth transmissions to begin at this time can, of course, move the ending boundary 785 farther away (towards the left) from the start of the next consecutive listening frame 710 designated as 3n+3. Doing so, however, should not lead to any collisions with the 802.16 communication; the next successive Bluetooth transmission and receive slots 760, 770 should still occur in the next sleep frame 710 (frame 3n+4) and there should be no UL burst 260 allocation to interfere with the Bluetooth transmissions that will happen in the following listening frame 710 (frame 3n+5).

It is important to note that the offsetting of the Bluetooth transmissions can apply to any time in this range that has been described above. In other words, the Bluetooth transmissions can start at approximately 2.5 ms after the end of a sleep frame 720 and any time beyond the sleep frame 720, so long as the end of the Bluetooth transmissions do not roll into the next consecutive listening frame 710.

It is understood in the art that the DL subframe 210 (see FIG. 3) may actually extend beyond the approximate temporal mid-point, 2.5 ms, of a listening frame 710. For example, considering the listening frame 710 designated as frame 3n+2, the DL subframe 210 may extend beyond the 2.5 ms arrow, in which case the DL burst 250 allocation may extend beyond this point, too. As such, the multi-mode device 100 can correspondingly arrange the starting boundary 780 of the Bluetooth transmissions around this scenario. In this case, the starting boundary 780 can be set to the end of the DL subframe 210 to avoid collisions with this DL burst 250. In view of this possibility, the starting boundary 780 can actually be set to the later of 2.5 ms from the end of the sleep frame 720 (e.g., frame 3n+1) or the end of the DL subframe 210 of the next consecutive listening frame 710 (e.g., frame 3n+2). In either alternative, no collisions should occur, as long as the ending boundary 785 does not go beyond the start of the next consecutive listening frame 710 (e.g., frame 3n+3).

In view of the above, collisions between an 802.16 communication and a Bluetooth communication can be avoided without affecting the quality of either transmission. Moreover, no special requirements are needed for the base station 110, as this approach is compatible with any WiMAX certified base station. The processes described above are also compatible with all standard 802.16e medium access control (MAC) features, and the arrangement of the Bluetooth communication does not require any onerous modifications. In fact, it is not necessary to develop a proprietary Bluetooth headset to facilitate this process, as it is fully supported as an optional feature by recent Bluetooth profiles. As noted earlier, additional DL allocations can be scheduled, and the power-saving benefit of using sleep frames is still realized with this invention. This invention is also compatible with various scheduling service classes, such as unsolicited grant service (UGS) and extended real-time polling service (ertPS).

Referring to FIG. 6 once again, at step 680, it can be determined whether the multi-mode device is the master of the relationship between the multi-mode device and the accessory. Also at step 680, the multi-mode device can be switched to the master if the multi-mode device is not designated as such to ensure that the multi-mode device is the master when the multi-mode device communicates with the accessory. As explained earlier, referring to FIG. 2, the device switching module 137 can initiate this process and can work with the switching module 160 of the accessory 120 to facilitate this switch.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for collision avoidance using sleep frames, comprising:
in a multi-mode device, conducting a communication in accordance with an 802.16 communications protocol, wherein the 802.16 communication protocol communication includes both listening frames and sleep frames;
conducting in the multi-mode device another communication in accordance with a Bluetooth communications protocol that supports extended synchronous connection-oriented mode;
arranging transmissions of the Bluetooth communication to avoid collisions with transmissions of the 802.16 communication.

2. The method according to claim 1, further comprising requesting from a base station that supports the 802.16 communication a cluster of frames having a designated number of listening frames and sleep frames.

3. The method according to claim 2, further comprising receiving from the base station a grant of the cluster of frames, wherein the cluster of frames includes two listening frames and one sleep frame, the listening frames and the sleep frames being approximately five milli-seconds in duration.

4. The method according to claim 3, wherein the listening frames include a downlink subframe and an uplink subframe and the method further comprises receiving downlink burst and uplink burst allocations respectively in the downlink subframe and the uplink subframe of the listening frames.

5. The method according to claim 4, wherein the Bluetooth communication includes a cycle time of approximately 7.5 milli-seconds, of which approximately 1.25 milli-seconds is occupied by a transmission slot and a receive slot.

6. The method according to claim 5, wherein arranging transmissions of the Bluetooth communication to avoid collisions with transmissions of the 802.16 communication comprises offsetting the boundaries of the transmission and receive slots of the Bluetooth communication with respect to the boundaries of the listening and sleep frames of the 802.16 communication such that the Bluetooth transmission and receive slots are transmitted at a time when no downlink or uplink bursts are scheduled to occur in the listening frames.

7. The method according to claim 6, wherein offsetting the boundaries of the transmission and receive slots of the Bluetooth communication comprises reading the sleep frame of the 802.16 communication and setting an ending boundary of the Bluetooth transmission and receive slots prior to the start of the next consecutive listening frame.

8. The method according to claim 6, wherein offsetting the boundaries of the transmission and receive slots of the Bluetooth communication comprises reading the sleep frame of the 802.16 communication and setting a starting boundary of the Bluetooth transmission and receive slots that is the later of approximately 2.5 milli-seconds from the end of the sleep frame or the end of the downlink subframe of the next consecutive listening frame.

9. The method according to claim 1, wherein the multi-mode device communicates with an accessory over the Bluetooth communications protocol and the multi-mode device is designated as a master.

10. The method according to claim 9, further comprising:
determining whether the multi-mode device is the master of the relationship between the multi-mode device and the accessory; and
switching the multi-mode device to the master if the multi-mode device is not designated as such to ensure that the multi-mode device is the master when the multi-mode device communicates with the accessory.

11. A method for collision avoidance using sleep frames, comprising:
at a base station that supports 802.16 communications, receiving from a multi-mode device through an 802.16 communication a request for a cluster of frames having a designated number of listening frames and sleep frames;
granting the request for the cluster of frames in which the cluster of frames includes two listening frames and one sleep frame; and
allocating uplink bursts and downlink bursts in the listening frames of the cluster of frames to permit the multi-mode device to arrange the transmissions of an extended synchronous connection-oriented Bluetooth communication to avoid collisions with the 802.16 communication.

12. The method according to claim 11, wherein the cluster of frames is approximately fifteen milli-seconds in duration and the listening frames and the sleep frame are approximately five milli-seconds in duration.

13. A multi-mode device, comprising:
a transceiver capable of conducting an 802.16 communication having both listening and sleep frames;
a transceiver capable of conducting an extended synchronous connection-oriented Bluetooth communication; and
a collision avoidance module coupled to the first and second transceivers, wherein the collision avoidance module arranges transmissions of the Bluetooth transceiver to avoid collisions with transmissions of the 802.16 transceiver.

14. The multi-mode device according to claim 13, wherein the collision avoidance module requests from a base station that supports 802.16 communications a cluster of frames having a designated number of listening frames and sleep frames.

15. The multi-mode device according to claim 14, wherein the 802.16 transceiver receives from the base station a grant of the cluster of frames, wherein the cluster of frames includes two listening frames and one sleep frame, the listening frames and the sleep frames being approximately five milli-seconds in duration.

16. The multi-mode device according to claim 15, wherein the listening frames include a downlink subframe and an uplink subframe and the 802.16 transceiver receives downlink burst and uplink burst allocations respectively in the downlink subframe and the uplink subframe of the listening frames.

17. The multi-mode device according to claim 16, wherein the Bluetooth communication includes a cycle time of approximately 7.5 milli-seconds, of which approximately 1.25 milli-seconds is occupied by a transmission slot and a receive slot.

18. The multi-mode device according to claim 17, wherein the collision avoidance module arranges transmissions of the Bluetooth transceiver to avoid collisions with transmissions of the 802.16 transceiver by offsetting the boundaries of the transmission and receive slots of the Bluetooth communication with respect to the boundaries of the listening and sleep frames of the 802.16 communication such that the Bluetooth transmission and receive slots are transmitted at a time when no downlink or uplink bursts are scheduled to occur in the listening frames.

19. The multi-mode device according to claim 18, wherein the collision avoidance module offsets the boundaries of the transmission and receive slots of the Bluetooth communication by reading the sleep frame of the 802.16 communication and setting an ending boundary of the Bluetooth transmission and receive slots prior to the start of the next consecutive listening frame.

20. The multi-mode device according to claim 18, wherein the collision avoidance module offsets the boundaries of the transmission and receive slots of the Bluetooth communication by reading the sleep frame of the 802.16 communication and setting a starting boundary of the Bluetooth transmission and receive slots that is the later of approximately 2.5 milli-seconds from the end of the sleep frame or the end of the downlink subframe of the next consecutive listening frame.

21. The multi-mode device according to claim 13, wherein the Bluetooth transceiver communicates with an accessory and the multi-mode device is designated as a master.

22. The multi-mode device according to claim 21, further comprising a device switching module, wherein the device switching module determines whether the multi-mode device is the master of the relationship between the multi-mode device and the accessory and switches the multi-mode device to the master if the multi-mode device is not designated as such to ensure that the multi-mode device is the master when the Bluetooth transceiver communicates with the accessory.

23. A base station that supports 802.16 communications, comprising:
a transceiver that receives from a multi-mode device through an 802.16 communication a request for a cluster of frames having a designated number of listening frames and sleep frames; and
a generating module, wherein the generating module:
grants the request for the cluster of frames in which the cluster of frames includes two listening frames and one sleep frame; and
allocates uplink bursts and downlink bursts in the listening frames of the cluster of frames to permit the multi-mode device to arrange the transmissions of an extended synchronous connection-oriented Bluetooth communication to avoid collisions with the 802.16 communication.

24. The base station according to claim 23, wherein the cluster of frames is approximately fifteen milli-seconds in duration and the listening frames and the sleep frame are approximately five milli-seconds in duration.
